(19) United States
(12) Patent Application Publication
(10) Pub. No.: US 2024/0356121 A1
(43) Pub. Date: Oct. 24, 2024

(54) SECONDARY BATTERY

(71) Applicant: Samsung SDI Co., Ltd., Yongin-si (KR)

(72) Inventors: Kwang Soo BAE, Yongin-si (KR); Jun Sun YONG, Yongin-si (KR); Jun Hyung LEE, Yongin-si (KR); Jung Soo KIM, Yongin-si (KR)

(21) Appl. No.: 18/485,221

(22) Filed: Oct. 11, 2023

(30) Foreign Application Priority Data
Apr. 21, 2023 (KR) 10-2023-0052503

(51) Int. Cl. H01M 50/176; H01M 10/0583; H01M 50/46; H01M 50/557

(52) U.S. Cl. CPC H01M 50/176; H01M 10/0583; H01M 50/461; H01M 50/557

(57) ABSTRACT

A secondary battery includes: an electrode assembly including a first electrode tab and a second electrode tab, the first electrode tab and the second electrode tab being exposed at opposite sides of the electrode assembly; a first collector electrically coupled to the first electrode tab; a case having two open sides and accommodating the electrode assembly and the first collector therein; a first cap plate sealing one of the open sides of the case; and a first terminal mechanically and electrically coupled to the first collector and exposed to the outside of the first cap plate. The first collector includes a protrusion protruding outwardly and coupled to the first terminal, and the first terminal has a terminal through-hole in which the protrusion is accommodated.

### CROSS-REFERENCE TO RELATED APPLICATION

The present application claims priority to and the benefit of Korean Patent Application No. 10-2023-0052503, filed on Apr. 21, 2023, in the Korean Intellectual Property Office, the entire disclosure of which is incorporated herein by reference.

### BACKGROUND

### 1. Field

Aspects of embodiments of the present disclosure relate to a secondary battery.

### 2. Description of the Related Art

A secondary battery is a power storage device that provides excellent energy density by converting electrical energy into chemical energy and storing the chemical energy. Compared to non-rechargeable (or primary) batteries, secondary batteries are rechargeable and are widely used for IT devices, such as smartphones, cellular phones, laptops, tablet PCs, and the like.

In recent years, interest in electric vehicles has increased as a way to reduce or prevent environmental pollution, and accordingly, high-capacity secondary batteries are being adopted for use in electric vehicles. Such secondary batteries need to have certain characteristics, such as high density, high output, and stability.

The above-described information disclosed in this Background section provides the background of the present disclosure and is for improving understanding of the same. Thus, this Background section may include information that does not constitute the related (or prior) art.

### SUMMARY

Embodiments of the present disclosure provide a secondary battery providing improved weldability between a terminal and a collector plate.

According to an embodiment of the present disclosure, a secondary battery includes: an electrode assembly including a first electrode tab and a second electrode tab, the first electrode tab and the second electrode tab being exposed at opposite sides of the electrode assembly; a first collector electrically coupled to the first electrode tab; a case having two open sides and accommodating the electrode assembly and the first collector therein; a first cap plate sealing one of the open sides of the case; and a first terminal mechanically and electrically coupled to the first collector and exposed to the outside of the first cap plate. The first collector includes a protrusion protruding outwardly and coupled to the first terminal, and the first terminal has a terminal through-hole in which the protrusion is accommodated.

An upper end surface of the protrusion and an upper end surface of the terminal through-hole may be welded and may form a planar surface.

A welding area between an upper end surface of the protrusion and an upper end surface of the terminal through-hole may be exposed to the outside of the first terminal.

The terminal through-hole may be defined in an area corresponding to a position of the protrusion.

The terminal through-hole may have a shape corresponding to that of an upper end surface of the protrusion.

The terminal through-hole may have a diameter equal to or greater than that of the protrusion.

The first terminal may have a circular shape.

The first terminal may have a rectangular shape.

The first collector may include: a first collector plate welded to the first electrode tab; and a second collector plate contacting an outer surface of the first collector plate and contacting and coupled to an inner surface of the first terminal.

The first collector plate may include: a central portion protruding outwardly, an outer area thereof being welded to an inside of the second collector plate; and a plurality of edge portions respectively extending from the central portion in opposite directions and welded to the first electrode tab of the electrode assembly.

The first collector plate may further include a plurality of connection portions respectively inclined from the central portion toward a corresponding one of the edge portions.

The central portion of the first collector plate may have a size less than that of an inner surface of the second collector plate.

The protrusion may protrude outwardly from a central area of the second collector plate.

The electrode assembly may be a Z-stack electrode assembly in which a positive electrode plate and a negative electrode plate are inserted into both sides of a separator that is folded in the form of a Z-stack.

In the electrode assembly, the separator may be fixed by an adhesive member.

The adhesive member may be inside the first collector.

The secondary battery may further include an insulating member between the first terminal and the first cap plate.

The secondary battery may further include a clad sheet between the first collector and the first terminal.

When the first terminal is a negative electrode, the first terminal and the first collector may be made of the same type of metal.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, explain aspects and features of the present disclosure. In the drawings:

FIG. 1 is a perspective view of a secondary battery according to embodiments;

FIG. 2 is a cross-sectional view taken of the secondary battery shown in FIG. 1 taken along the line 2-2′;

FIG. 3 is an enlarged cross-sectional view of a portion of the secondary battery shown in FIG. 2;

FIG. 4 is an exploded perspective view of a terminal and a collector of the secondary battery before they are coupled to each other;

FIG. 5 is a perspective view of a circular terminal in a secondary battery according to embodiments of the present disclosure;

FIG. 6A is an exploded perspective view of the circular terminal of the secondary battery shown in FIG. 5 before it is coupled to the collector; and

FIG. 6B is a perspective view of the circular terminal and the collector coupled to each other.

### DETAILED DESCRIPTION

Embodiments of the present disclosure may, however, be embodied in many different forms and should not be construed as being limited to the embodiments set forth herein. Rather, these embodiments are provided so that this disclosure will be thorough and complete and will fully convey the scope of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Hereinafter, embodiments of the present disclosure will be described, in detail, with reference to the accompanying drawings so that those skilled in the art can easily implement the present disclosure.

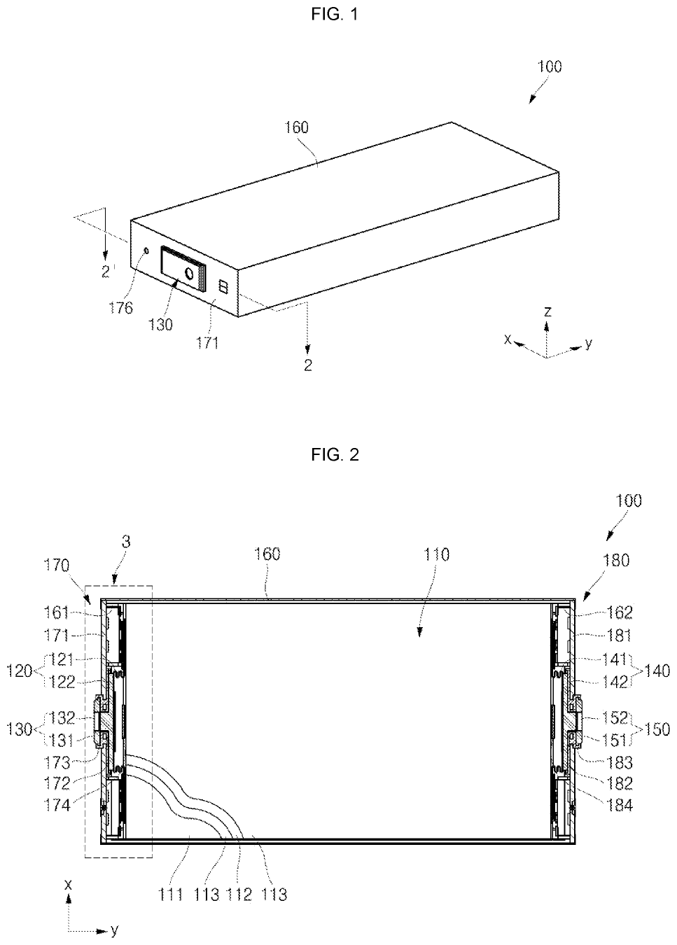

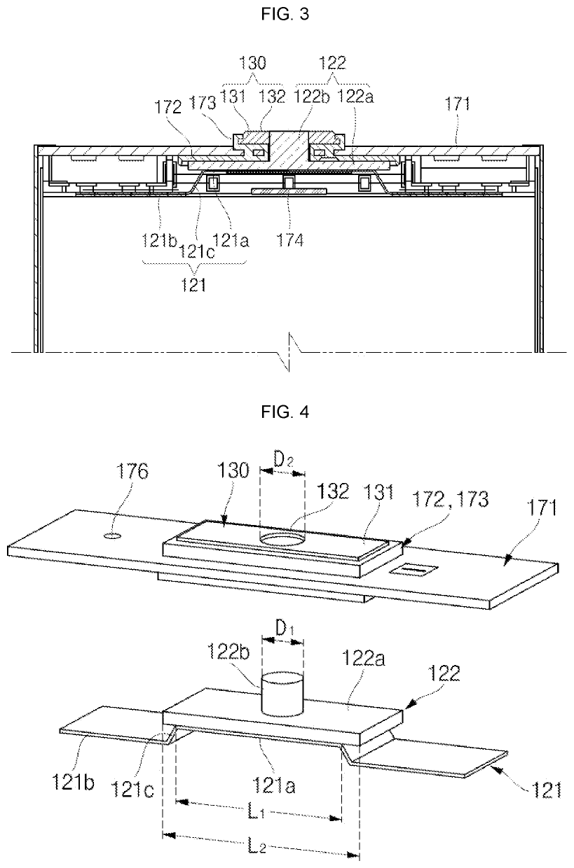

FIG. 1 is a perspective view of a secondary battery according to embodiments, FIG. 2 is a cross-sectional view taken along the line 2-2′ in FIG. 1, and FIG. 3 is an enlarged cross-sectional view of a portion of the secondary battery shown in FIG. 2. Hereinafter, a structure of the secondary battery 100, according to embodiments of the present disclosure, will be described.

As illustrated in FIGS. 1 to 3, the secondary battery 100 may include an electrode assembly 110, a first collector 120, a first terminal 130, a second collector 140, a second terminal 150, a case 160, a first cap assembly 170, and a second cap assembly 180.

The electrode assembly 110 may be provided by winding or stacking a stack of a first electrode plate 111, a separator 113, and a second electrode plate 112, each of which is provided in a thin plate shape or film shape. When the electrode assembly 110 is a rolled stack, a winding axis may be parallel to a longitudinal direction (e.g., the y direction) of the case 160. In some embodiments, the electrode assembly 110 may be a stacked-type electrode assembly rather than a winding-type, but the shape or type of the electrode assembly 110 is not limited. In some embodiments, the electrode assembly 110 may be a Z-stack electrode assembly in which the first electrode plate 111 and the second electrode plate 112 are inserted into both sides of the separator 113, which is then folded (or bent) in the form of a Z-stack. In some embodiments, the electrode assembly 110 may be stacked so that one or more electrode assemblies 110 are adjacent to each other and accommodated in the case 160. The number of electrode assemblies 110 in the case 160 is not limited.

The first electrode plate 111 of the electrode assembly 110 may act as a negative electrode, and the second electrode plate 112 may act as a positive electrode, but the opposite may also be true.

The first electrode plate 111 may be formed by applying a first electrode active material, such as graphite or carbon, to a first electrode collector made of a metal foil, such as copper, a copper alloy, nickel, or a nickel alloy. The first electrode plate 111 may include a first electrode tab (e.g., a first non-coating portion) that is not coated with the first electrode active material. The first electrode tab may be a passage through which current flows between the first electrode plate 111 and the first collector 120. In some embodiments, the first electrode tab may be formed by being cut in advance to protrude to one side when the first electrode plate 111 is manufactured and may protrude more to one side than the separator 113, which is not cut.

The second electrode plate 112 may be provided by applying a second electrode active material, such as transition metal oxide, to a second electrode collector made of metal foil, such as aluminum or an aluminum alloy. The second electrode plate 112 may include a second electrode tab (e.g., a second non-coating portion) that is not coated with the second electrode active material. The second electrode tab may be a passage through which current flow between the second electrode plate 112 and the second collector 140. In some embodiments, the second electrode tab may be formed by being cut in advance to protrude to the other side when the second electrode plate 112 is manufactured and may protrude more to the other side than the separator 113, which is not cut.

In some embodiments, the first electrode tab may be located on a side surface at a left end of the electrode assembly 110, and the second electrode tab may be located on a side surface at a right end of the electrode assembly 110. Here, the left and right sides are referred to for convenience of explanation based on the orientation of the secondary battery 100 in FIGS. 1 and 2, and the orientation of the secondary battery 100 may be changed when the secondary battery 100 is rotated left and right or up and down. Hereinafter, each component will be described based on the orientation of the secondary battery 100 in FIGS. 1 to 3.

In some embodiments, the separator 113 may be interposed between the first electrode plate 111 and the second electrode plate 112 to prevent a short circuit therebetween while enabling movement of lithium ions therebetween. The separator 113 may include polyethylene, polypropylene, or a composite film of polyethylene and polypropylene. In some embodiments, the separator 113 may be replaced with an inorganic solid electrolyte, such as a sulfide, an oxide, or a phosphate compound, which does not require a liquid or gel electrolyte.

The first electrode tab of the first electrode plate 111 and the second electrode tab of the second electrode plate 112 may be respectively located at both ends of the electrode assembly 110, as described above. In some embodiments, the electrode assembly 110 may be accommodated in the case 160 together with the electrolyte. In some embodiments, the electrolyte may include an organic solvent, such as EC, PC, DEC, EMC, or DMC, and a lithium salt, such as LiPF₆ or LiBF₄. In some embodiments, the electrolyte may be a liquid or a gel phase. In some embodiments, an inorganic-based solid electrolyte may be used such that a liquid or gel electrolyte may be omitted.

In addition, in the electrode assembly 110, the first collector 120 and the second collector 140 may be welded and connected to the first electrode tab of the first electrode plate 111 and the second electrode tab of the second electrode plate 112, which are exposed at both sides of the electrode assembly 110, respectively.

FIG. 4 is an exploded perspective view before the terminal and the collector of the secondary battery are coupled to each other. Referring to FIG. 4, a structure and a coupling structure of the first collector 120 will be described.

The first collector 120 may be made of a metal and may electrically connect the first electrode plate 111 and the first terminal 130 to each other. In some embodiments, the first collector 120 may be accommodated inside the case 160 and interposed between the first cap plate 171 and the electrode assembly 110.

Referring to FIG. 4, the first collector 120 may include a first collector plate (e.g., a first collector) 121 that is in contact with and coupled to the first electrode tab (e.g., the non-coating portion) of the first electrode plate 111 and a second collector plate (e.g., a second collector) 122 that is in contact with and coupled to the first terminal 130. The first collector plate 121 and the second collector plate 122 may be integrally formed or separably provided. The first collector 120 may be made of copper or a copper alloy.

The first collector plate 121 may extend (e.g., may primarily extend) in a first direction (e.g., the x direction), which is a longitudinal direction of the first cap plate 171 that is on one surface of the electrode assembly 110 and may have a substantially plate shape. The first collector plate 121 may have the same polarity as the first electrode plate 111 by being coupled thereto by welding in the state of being in contact with the first electrode tab exposed at one end of the electrode assembly 110.

The first collector 121 may have a central portion 121a having a central area protruding outwardly (e.g., protruding away from the electrode assembly 110) and edge portions 121b extending in both directions from the central portion 121a. An outer surface of the central portion 121a may be coupled to an inner side of the second collector 122 by welding. The inner surface of the edge portion 121b may be welded and coupled to the first electrode tab of the electrode assembly 110. Compared to the edge portion 121b, the central portion 121a may protrude in an outwardly direction in which the first cap plate 171 is located. The central portion 121a may be spaced apart from one surface (e.g., from the nearest surface) of the electrode assembly 110.

A connection portion 121c bent from the central portion 121a toward the edge portion 121b may be formed between the central portion 121a and the edge portion 121b. The central portion 121a may be disposed closer to a side of the first cap plate 171 than the edge portion 121b is.

In some embodiments, the first collector 121 may have the connection portion 121c and the edge portion 121b, which are provided at both sides in the first direction (e.g., the x direction) with the central portion 121a as a center. In some embodiments, because the first collector 120 is provided to protrude outwardly by the connection portion 121c, a space may be defined inside (or under) the first collector 120. A first glue member (e.g., a first adhesive member) 174 may be provided in the space to fix the separator of the electrode assembly 110.

In some embodiments, referring to FIG. 4, a size of the central portion 121a of the first collector 121 may be less than that of the inner surface of the second collector 122. In some embodiments, a length L1 of the central portion 121a of the first collector 121 in the first direction (e.g., the x direction) may be less than a length L2 of the inner surface of the second collector 122. In some embodiments, an area of the central portion 121a of the first collector 121 may be less than that of the inner surface of the second collector 122.

The second collector 122 may extend in the first direction (e.g., the x direction) and may have a substantially plate shape. The second collector plate 122 may be in contact with an outer surface of the first collector plate 121 and may be in contact with and welded to the inner surface of the first terminal 130.

A size of the inner surface of the second collector plate 122 may be greater than that of the central portion 121a of the first collector plate 121. In some embodiment, the length L2 of the inner surface of the second collector 122 in the first direction may be greater than the length L1 of the central portion 121a of the first collector 121.

The second collector 122 may include a protrusion 122b protruding outwardly from a central area 122a of the outer surface. The outer surface of the protrusion 122b may be coupled to (or may contact) the inner surface of the first terminal 130 by welding.

The first terminal 130 may be made of a metal and may be electrically connected to (and may contact) the protrusion 122b by welding. In some embodiments, the first terminal 130 may include a first terminal plate 131 having a first terminal through-hole (e.g., a first terminal opening) 132. In some embodiments, the protrusion 122b may pass through and may be accommodated in the first terminal through-hole 132.

The first terminal 130 may be made of aluminum or an aluminum alloy. In some embodiments, when the first terminal 130 is the negative electrode, the first terminal 130 and the first collector 120 may be made of the same metal. However, in some embodiments, the first terminal 130 and the first collector 120 may be made of different metals. In some embodiments, a clad sheet may be provided between the first terminal 130 and the first collector 120. The clad sheet may couple and electrically connect the first terminal 130 to the first collector 120 when they are made of different metals. The clad sheet may be a sheet in which an aluminum sheet and a copper sheet are bonded by thermal compression. For example, the clad sheet may be a sheet in which aluminum, having a thickness of about 2 T, and copper, having a thickness in a range of about 0.5 T to about 0.7 T, are bonded by thermal compression. The aluminum sheet of the clad sheet may be coupled to the first terminal 130 by welding, and the copper sheet may be coupled to the first collector 120 by welding.

The first terminal plate 131 may be located outside or above the first cap plate 171. In some embodiments, the first terminal through-hole 132 may extend in an inwardly direction from an outer surface of the first terminal plate 131. An area of the first terminal plate 131 at where the first terminal through-hole 132 is provided may have a thickness less than that of each of other areas. The first terminal plate 131 may be welded to the second collector plate 122 outside the first cap plate 171 through the first terminal through-hole 132.

In some embodiments, a top surface of the protrusion 122b of the second collector plate 122 and a top surface of the first terminal through-hole 132 may be welded on the same line (e.g., may form a planar surface). In some embodiments, because the protrusion 122b is accommodated in the first terminal through-hole 132, a diameter D1 of the protrusion 122b may be equal to or less than a diameter D2 of the first terminal through-hole 132.

The first terminal through-hole 132 may be defined in a partial area of the first terminal plate 131. The first terminal through-hole 132 may be defined in a substantially central area of the first terminal plate 131 or in an area corresponding to the protrusion 122b of the second collector 122.

In some embodiments, a first insulating member 172 may be further interposed between the first terminal plate 131 and the first cap plate 171. In some embodiments, a first seal gasket 173 may be further interposed between the outer surface of the first terminal plate 131 and the first cap plate 171 to seal the space between the first terminal 130 and the first cap plate 171.

In one embodiment, the first terminal plate 131 may be in contact with and coupled to the second collector 122 of the first collector 120 at one surface. In some embodiments, the first terminal plate 131 of the first terminal 130 may be exposed and protrude from the outside of the first cap plate 171.

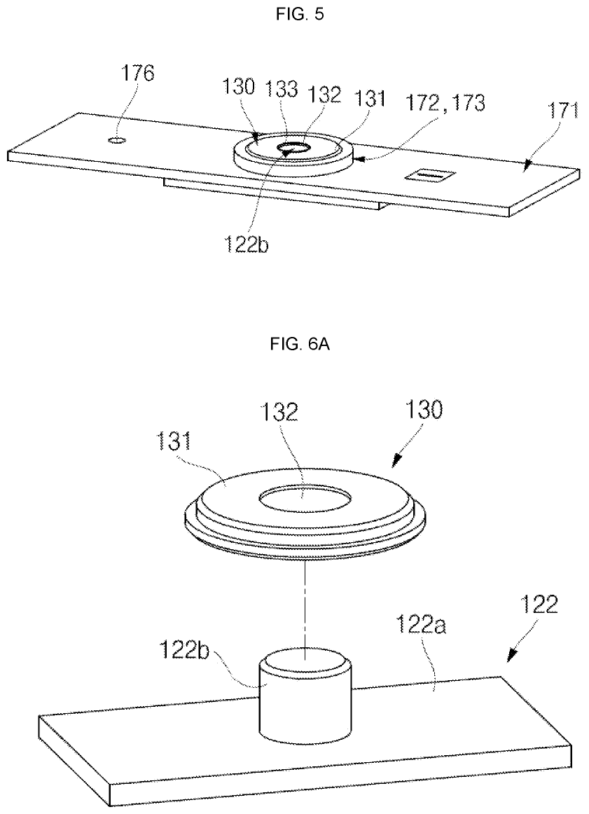

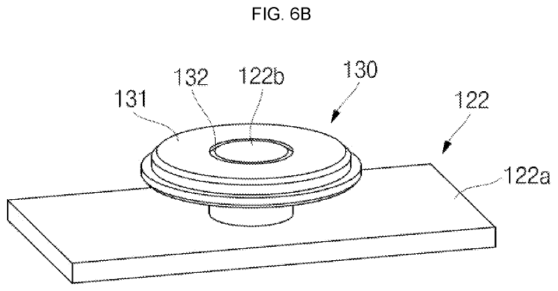

In some embodiments, the first terminal 130 may be provided in a rectangular shape, as illustrated in FIG. 4, but is not limited thereto. Referring to FIGS. 5 and 6, in some embodiments, the first terminal 130 may be provided in a circular shape.

FIG. 5 is a perspective view of a circular terminal in the secondary battery according to embodiments of the present disclosure, FIG. 6A is an exploded perspective view of the circular terminal of the secondary battery shown in FIG. 5 before it is coupled, and FIG. 6B is a perspective view of the circular terminal shown in FIG. 5 and the collector coupled to each other.

As illustrated in FIG. 5, because the top surface of the protrusion 122b and the top surface of the first terminal through-hole 132 are welded on the same line, the protrusion 122b may be exposed to the outside, and the welding area 133 may be exposed to the outside. Even when the first terminal 130 is provided as the circular terminal, a first insulating member 172 may be interposed between the first terminal plate 131 and the first cap plate 171. In some embodiments, the first seal gasket 173 having the circular shape may be interposed between the outer surface of the first terminal plate 131 and the first cap plate 171 to seal the space between the first terminal 130 and the first cap plate 171. In some embodiments, a protruding height of the protrusion 122b may be the same as the total height of the first cap plate 171, the first insulating member 172, the first seal gasket 173, and the first terminal plate 131 when they are coupled to each other.

As illustrated in FIGS. 6A and 6B, the circular first terminal 130 may have a first terminal through-hole 132 through which the circular first terminal plate 131 and the circular protrusion 122b pass. The first terminal through-hole 132 may be defined in a partial area of the first terminal plate 131. The first terminal through-hole 132 may be defined in a substantially central area of the first terminal plate 131 or in an area corresponding to the protrusion 122b of the second collector 122. In some embodiments, the protrusion 122b may be accommodated in the first terminal through-hole 132 and may be fitted up to a portion at which an upper end surface of the protrusion 122b is located on the same line as an upper end surface of the first terminal through-hole 132.

As described above, the first terminal plate 131 may be welded to the second collector plate 122 outside the first cap plate 171 through the first terminal through-hole 132. In some embodiments, a welding area 133 may be formed along a circumference of the upper end surface of the protrusion 122b and a circumference of the upper end surface of the first terminal through-hole 132. Therefore, in some embodiments, because the welding area 133 is exposed to the outside, a shape of a welding bead may be directly confirmed (e.g., visually confirmed) from the outside, and thus, welding quality may be easily checked and a non-destructive inspection (e.g., a CT or shearography) process of a welded part may be replaced with a vision inspection and low resistance process (or test).

The second collector 140 may be made of a metal and may electrically connect the second electrode plate 112 and the second terminal 150 to each other. The second collector 140 may be provided as a metal plate and may include a third collector plate 141 that is in contact with and coupled to the second electrode tab of the second electrode plate 112 and a fourth collector plate 142 that is in contact with and coupled to the second terminal 150. In some embodiments, the second collector 140 may be coupled to the electrode assembly 110 and the second terminal 150 in a shape that is symmetrical to the first collector 120 with respect to the electrode assembly 110. In some embodiments, the second collector 140 may be made of aluminum or an aluminum alloy.

The second terminal 150 may be made of a metal and may be electrically connected to the second collector 140. In some embodiments, the second terminal 150 may include a second terminal plate 151 having a second terminal through-hole (e.g., a second terminal opening) 152.

In some embodiments, the second terminal plate 151 may be located inside (e.g., under) the second cap plate 181. In some embodiments, a second insulating member 182 may be interposed between the second terminal plate 151 and the second cap plate 181. In some embodiments, a second seal gasket 183 may be interposed between the second terminal plate 151 and the second cap plate 181.

The second terminal 150 may have the same shape and structure as the first terminal 130. However, the second terminal 150 may be coupled to the electrode assembly 110 through the second collector 140 in a shape that is symmetrical to the first terminal 130 with respect to the electrode assembly 110. In some embodiments, the second terminal 150 may be made of aluminum or an aluminum alloy. In some embodiments, because the second terminal 150 and the second collector 140 are made of the same metal, the second terminal 150 and the second collector 140 may be directly coupled to each other by welding.

In some embodiments, a protruding portion of the second collector 140 may pass through and be accommodated in the second terminal through-hole 152 in the second terminal 150. In some embodiments, an upper end surface of the second terminal through-hole 152 and an upper end surface of the second collector 140 may be welded on the same line (e.g., may form a planar surface).

The case 160 may have a hollow substantially rectangular parallelepiped shape with openings 161 and 162 defined at both sides (or both ends), and the electrode assembly 110 may be inserted into the case 160 through opening 161 or 162 in a state in which it is coupled to the first and second collectors 120 and 140.

The case 160 may have two long side surfaces in a rectangular shape, which connect (or extend between) top and bottom surfaces extending in a second direction (e.g., the y direction), that is a longitudinal direction, to a long side between the top and bottom surfaces and extend in the second direction (e.g., the y direction). In the case 160, the top and bottom surfaces and the two long side surfaces may be integrated with (e.g., may be integrally formed with) each other.

The case 160 may have a vent hole (e.g., a vent opening) passing through one of the long side surfaces. A safety vent may be installed in the vent hole in the case 160. In some embodiments, the safety vent may be provided with (or may be provided as) a notch that is thinner than other areas to open (or burst) at a set (or reference) pressure.

The first cap assembly 170 may be coupled at the left opening 161 in the case 160. In some embodiments, the first cap assembly 170 may include a first cap plate 171, a first insulating member 172, a first seal gasket 173, and a first glue member (e.g., a first adhesive member) 174.

The first cap plate 171 may have a flat rectangular plate shape to seal the left opening 161 in the case 160. The first cap plate 171 may have a first terminal through-hole (e.g., a first terminal opening) 132 passing between an outer surface and an inner surface thereof and an electrolyte injection port. The protrusion 122b of the second collector plate 122 may pass through the first terminal through-hole 132 in the first cap plate 171 and may be coupled to the first terminal plate 131. In some embodiments, after the first cap plate 171 is coupled to the case 160 and the electrolyte is injected into the case 160, the electrolyte injection port may be sealed by a stopper 176.

The first insulating member 172 may be interposed between the inner surface of the first cap plate 171 and the first terminal plate 131. The first insulating member 172 may be in close contact with the inner surface of the first cap plate 171 and may also be in close contact with the first seal gasket 173. The first insulating member 172 may be made of an insulating material to insulate the first cap plate 171 and the first terminal plate 131 from each other.

In some embodiments, the first seal gasket 173 may be made of an insulating material and may be provided between the first cap plate 171 and the first terminal plate 131 or on the outer surface of the first terminal plate 131 to seal a gap between the first cap plate 171 and the first terminal plate 131. The first seal gasket 173 may prevent external moisture from penetrating into the secondary battery 100 or prevent the electrolyte contained in the secondary battery 100 from leaking to the outside. The first seal gasket 173 may be manufactured with the first insulating member 172 by using an insert molding method.

In some embodiments, the first seal gasket 173 may be integrated with the first insulating member 172 by injection molding and may be interposed between the first terminal 130 and the first cap plate 171. In some embodiments, the first cap plate 171 may be electrically separated from (e.g., electrically insulated from) the first terminal 130 and the second collector plate 122 by the first insulating member 172 and the first seal gasket 173.

The second cap assembly 180 may be coupled at the right opening 162 in the case 160. In some embodiments, the second cap assembly 180 may include a second cap plate 181, a second insulating member 182, a second seal gasket 183, and a second glue member (e.g., a second adhesive member) 184. The second cap assembly 180 may have the same shape and structure as the first cap assembly 170. In some embodiments, the coupling shape and structure of the second cap assembly 180 and the second terminal 150 may be the same as those of the first cap assembly 170 and the first terminal 130. However, the coupling shape of the second cap assembly 180 and the second terminal 150 may be symmetrical to the coupling shape of the first cap assembly 170 and the first terminal 130 with respect to the case 160.

In the secondary battery 100, the first cap assembly 170 coupled to the first terminal 130 may be coupled to an opening at one side of the case 160, and the second cap assembly 180 coupled to the second terminal 150 may be coupled to an opening at the other (e.g., the opposite) side of the case 160. Thus, the first terminal 130 and the second terminal 150 may be located at opposite sides of the case 160 with the case 160 as a center. The secondary battery 100 may be provided with the first terminal 130 and the second terminal 150 at both the sides thereof, and thus, if a plurality of secondary batteries 100 are coupled together in the form of a module, a cooling member may be coupled to each of the upper and lower areas of the case 160. In some embodiments, deterioration of the secondary battery 100 may be reduced by improved cooling performance.

For example, in the battery module, when the long side surfaces of the plurality of secondary batteries 100are disposed to face each other, the first terminals 130 and/or the second terminals 150, which are respectively exposed at both sides of each secondary battery 100, may be electrically connected to each other.

In some embodiments, the first terminal 130 and the second terminal 150 may be provided at both the sides of the secondary battery 100. Thus, if the plurality of secondary batteries are coupled together in the form of the module, because charging/discharging current flows along each terminal at both the sides, the two terminals may be provided at opposite sides to prevent deterioration of the electrode assembly 110 that may occur compared to a case in which the charging/discharging current flows along two terminals at one side (e.g., at the same side) of the case. In some embodiments, if the plurality of secondary batteries 100 are coupled together in the form of the module, space utilization may be improved because the respective terminals are connected to each other at both of the sides.

According to embodiments of the present disclosure, the collector plate may be exposed to the outside so that the welding is easily performed. As a result, direct welding between the terminal and the collector plate may be performed, and the shape of the welding bead may be directly confirmed (e.g., visually confirmed) to improve the weldability of the terminal and the collector plate.

In addition, according to embodiments of the present disclosure, the shape of the welding bead may be directly confirmed (e.g., visually confirmed), and thus, it may be easy to confirm the welding quality, and a CT or shearography process may be replaced with a vision inspection and low-resistance inspection.

The above-mentioned embodiments are merely some embodiments of the secondary battery according to the present disclosure, and thus, the present disclosure is not limited to the foregoing embodiments. It will be understood by those of ordinary skill in the art that various changes in form and details may be made therein without departing from the spirit and scope of the present disclosure as defined by the following claims and their equivalents.

What is claimed is:

1. A secondary battery comprising:
an electrode assembly comprising a first electrode tab and a second electrode tab, the first electrode tab and the second electrode tab being exposed at opposite sides of the electrode assembly;
a first collector electrically connected to the first electrode tab;
a case having two open sides and accommodating the electrode assembly and the first collector therein;
a first cap plate sealing one of the open sides of the case; and
a first terminal electrically connected to the first collector and exposed to the outside of the first cap plate,
wherein the first collector comprises a protrusion protruding outwardly and coupled to the first terminal, and
wherein the first terminal has a terminal through-hole in which the protrusion is accommodated.

2. The secondary battery as claimed in claim 1, wherein an upper end surface of the protrusion and an upper end surface of the terminal through-hole are welded and form a planar surface.

3. The secondary battery as claimed in claim 1, wherein a welding area between an upper end surface of the protrusion and an upper end surface of the terminal through-hole is exposed to the outside of the first terminal.

4. The secondary battery as claimed in claim 1, wherein the terminal through-hole is defined in an area corresponding to a position of the protrusion.

5. The secondary battery as claimed in claim 1, wherein the terminal through-hole has a shape corresponding to that of an upper end surface of the protrusion.

6. The secondary battery as claimed in claim 1, wherein the terminal through-hole has a diameter equal to or greater than that of the protrusion.

7. The secondary battery as claimed in claim 1, wherein the first terminal has a circular shape.

8. The secondary battery as claimed in claim 1, wherein the first terminal has a rectangular shape.

9. The secondary battery as claimed in claim 1, wherein the first collector comprises:
a first collector plate welded to the first electrode tab; and
a second collector plate contacting an outer surface of the first collector plate and contacting and coupled to an inner surface of the first terminal.

10. The secondary battery as claimed in claim 9, wherein the first collector plate comprises:
a central portion protruding outwardly, an outer area thereof being welded to an inside of the second collector plate; and
a plurality of edge portions respectively extending from the central portion in opposite directions and welded to the first electrode tab of the electrode assembly.

11. The secondary battery as claimed in claim 10, wherein the first collector plate further comprises a plurality of connection portions respectively inclined from the central portion toward a corresponding one of the edge portions.

12. The secondary battery as claimed in claim 10, wherein the central portion of the first collector plate has a size less than that of an inner surface of the second collector plate.

13. The secondary battery as claimed in claim 9, wherein the protrusion protrudes outwardly from a central area of the second collector plate.

14. The secondary battery as claimed in claim 1, wherein the electrode assembly is a Z-stack electrode assembly in which a positive electrode plate and a negative electrode plate are inserted into both sides of a separator that is folded in the form of a Z-stack.

15. The secondary battery as claimed in claim 14, wherein, in the electrode assembly, the separator is fixed by an adhesive member.

16. The secondary battery as claimed in claim 15, wherein the adhesive member is inside the first collector.

17. The secondary battery as claimed in claim 1, further comprising an insulating member between the first terminal and the first cap plate.

18. The secondary battery as claimed in claim 1, further comprising a clad sheet between the first collector and the first terminal.

19. The secondary battery as claimed in claim 1, wherein, when the first terminal is a negative electrode, the first terminal and the first collector are made of the same type of metal.
